(19) United States
(12) Patent Application Publication
(10) Pub. No.: US 2016/0000107 A1
(43) Pub. Date: Jan. 7, 2016

(54) METHOD AND SYSTEM FOR FLASH FREEZING WHEY LIQUID AND MAKING BEVERAGES THEREFROM

(71) Applicant: Curt Jones, Brentwood, TN (US)

(72) Inventors: Curt Jones, Brentwood, TN (US); Robert Lynn, Santa Monica, CA (US); Stan Jones, Vienna, IL (US)

(21) Appl. No.: 14/855,022

(22) Filed: Sep. 15, 2015

Related U.S. Application Data
(63) Continuation of application No. 13/183,682, filed on Jul. 15, 2011.

(51) Int. Cl. A23C 21/00; A23C 21/08; A23C 3/04; A23C 21/06

(52) U.S. Cl. CPC A23C 21/00; A23C 21/06; A23C 21/08; A23C 3/045

(57) ABSTRACT

An apparatus and method of flash freezing a whey-based liquid into small beads and then packaging the beads for consumers is disclosed. The beads are stored in a conventional freezer, or colder, until desired. The beads can be consumed in their frozen form to provide a convenient source of protein or can be reconstituted into a beverage base as needed. In particular, a warm or cold beverage may be easily and affordably created using the frozen beads.

### CROSS-REFERENCE TO RELATED APPLICATION

This application is a continuation application claiming priority benefit to U.S. patent application Ser. No. 13/183,682, filed on Jul. 15, 2011, which claims priority to U.S. Provisional Application 61/399,696, filed on Jul. 16, 2010. The entire contents and disclosures of the above applications are incorporated herein by reference.

### FIELD OF THE INVENTION

The present invention relates to beverages and more particularly to an apparatus and method for creating a flash frozen whey pellets or beverage.

### BACKGROUND OF THE INVENTION

Various products are available for individuals that value nutrition to help them supplement the amount of protein they consume. For example, protein powder is one example of a product that is routinely used by weightlifter, bodybuilders, and other athletes to create beverages that are high in protein. Using such beverages it is easier to consume larger amounts of protein without requiring large amounts of solid food to be consumed. There are many forms of protein powders available in the marketplace and some are mostly or completely made from whey. Whey is a by product of some other dairy processes and capturing it to make another usable and sellable product is beneficial and economical.

These protein drinks are available that have different ingredients that are intended to provide protein, amino acids, and other supplements that are believed helpful in training and nutrition. Some drinks are served chilled, some hot, and some with extra ingredients and toppings as well. Regardless of the way most whey-based drinks are served, they typically are served in a ready-to-go can or bottle or concocted by a person at a fitness center or at home.

The flavor and palatability of some drinks suffer if not mixed sufficiently, not served at a low enough temperature, or not concocted of an agreeable combination of ingredients.

There remains the need, therefore, for a product and method of its manufacture and use which allows quality whey pellets or drinks to be easily and affordably produced by a typical consumer and that have an extended shelf life.

### SUMMARY OF THE INVENTION

Embodiments of the present invention relate to a method of flash freezing a whey-based liquid into small beads and then packaging the beads for consumers. The beads are stored in a conventional freezer, or colder, until desired and then are reconstituted into a beverage as needed or consumed in their beaded form. In particular, a cold or warm whey-based beverage may be easily and affordably created using the frozen beads.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts flash freezing apparatus in accordance with the principles of the present invention.

FIG. 2 depicts exemplary beads in accordance with the principles of the present invention.

FIG. 3 depicts a flowchart of an exemplary method for making flash frozen whey-based beads according to an embodiment of the present invention.

FIG. 4 depicts a flowchart of an exemplary method of making a whey-based beverage in accordance with the principles of the present invention.

FIG. 5 depicts a flowchart of an alternative exemplary method of making a whey-based beverage in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the present disclosure, the term “whey-based” liquid is meant to refer to a liquid in which the major, non-water component is whey. The liquid could, however, include other ingredients to help stabilize it, to help affect its melting temperature, to help set its glass transition temperature, to help it texture and mouth-feel when consumed, to provide additional nutritional benefits, and to provide flavor or color. Additionally, not all protein powders and/or liquids are whey-based so the described beads can be formulated of high-protein liquids having a principle ingredient other than whey.

As a result of the methods described herein, there are provided formulations of frozen whey-based liquid in the form of small particulate shapes that remain free-flowing during storage and which can be used alone or in combination to be reconstituted into various beverages, or consumed in their beaded form. The particulate shapes, generally referred to as “beads”, may have a generally spherical, spheroid shape but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes will preferably have a diameter of about 5 mm or less but can also be larger such as between about 6 and about 10 mm. Particulate shapes having diameters outside these ranges are also contemplated. For non-spherical shapes which do not have a conventional diameter, the diameter is considered to be the diameter of the smallest sphere into which the particulate shape would fit.

It is desired that the particulate or beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

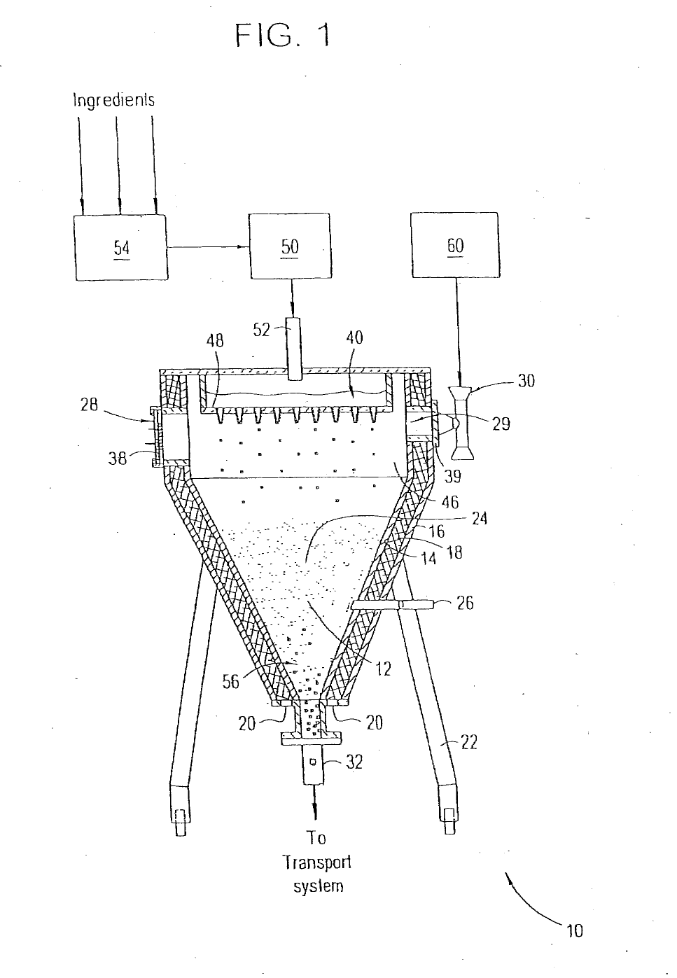

FIG. 1 shows a cryogenic processor constructed in accordance with an embodiment of the present invention to produce free-flowing beads 56.

A cryogenic processor 10 includes a freezing chamber 12 that is most preferably in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create relatively uniformly sized particles or beads 56 of frozen product, uniformly sized droplets of liquid composition are desirable that are to be fed through gas diffusion chamber 46 to freezing chamber 12. The feed tray 48 is designed with feed assembly 40 that forms droplets of the desired character. The frozen product takes the form of beads that are formed when the droplets of liquid composition contact the refrigerant vapor in the gas diffusion chamber 46, and subsequently the liquid refrigerant 24 in the freezing chamber 12. After the beads 56 are formed, they fall or are mechanically directed to the bottom of chamber 12. A transport system connects to the bottom of chamber 12 at outlet 32 to carry the beads 56 to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow desired.

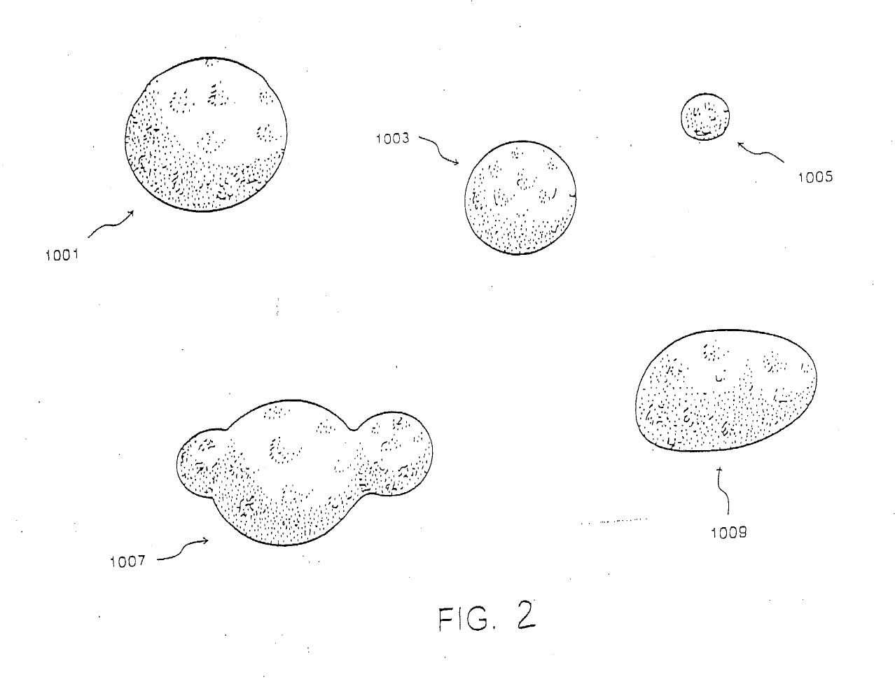

In accordance with preferred embodiments, there are provided formulations of frozen whey-based liquid confections in the form of small particulate shapes. The particulate shapes may have a generally spherical, spheroid shape as shown in FIG. 2 (e.g., 1001, 1003, 1005), but may also have an oblong, elliptical, oblate, tubular, or other slightly irregular shape as also shown in FIG. 2 (e.g., 1007, 1009). In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

As mentioned earlier, it is desired that the beaded product is in a free-flowing format so that it is readily pourable or spoonable. Free-flowing, as used herein, is a broad term which includes the ability of the product to flow as individual particulate shapes, with little or no clumping or sticking to each other, during such pouring or spooning. There may be slight sticking after a period of storage, but a light tap on the container will unstick the particulate shapes and allow them to be free flowing. The generally spherical shape helps contribute to the free-flowing, pourable product.

In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used. Storage at even colder temperatures is contemplated as well.

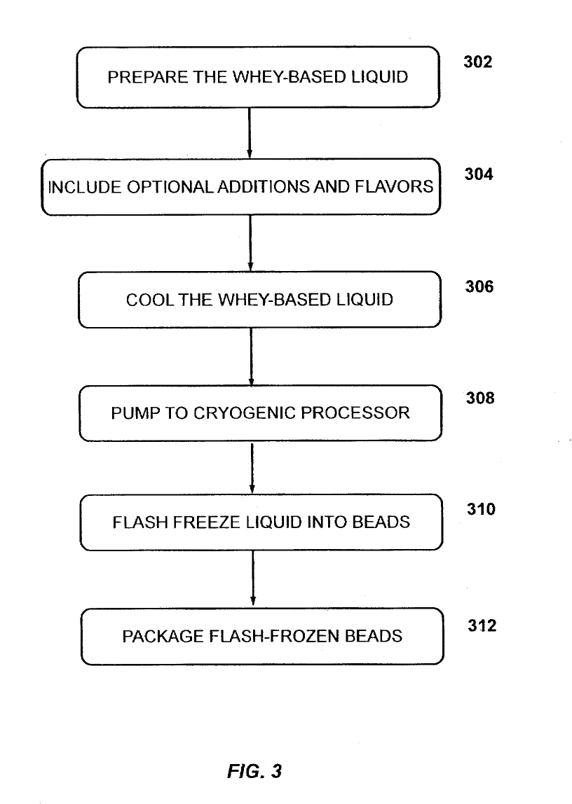

FIG. 3 depicts a flowchart of an exemplary method of making whey-based liquid particulate beads in accordance with the principles of the present invention.

The first step 302 shown in FIG. 3 is that of preparing the whey-based liquid. While the base ingredient of this liquid is the whey-based liquid formulation, there are a number of additional ingredients and flavors that may be added as well during the preparation process, in accordance with other embodiments. Dairy products, flavored syrups, flavored oils, sugars, sweeteners, herbs, spices and the like may be added, for example in a raw form or pre-processed form. In preparing the whey-based liquid, the liquid may be processed to have a particular strength, caffeine content, or other desired characteristic. Also, flavors from various liqueurs and syrups, as well as the ingredients listed above, may be part of the formulation as well, either before or after the whey-based liquid is prepared. The number of various formulations that may be turned into whey-based liquids in accordance with the principles of the present invention are limited only by the creativity of the food scientist and the preferences of consumers.

Once the liquid is prepared, another opportunity exists, at step 304, to add additional flavors, ingredients or additives in order to formulate a variety of different liquids. In step 306, the whey-based liquid is cooled if desired. The cooling can be accomplished by a variety of different methods that are well known. Preferably the liquid is cooled to about 40° F. in a matter of minutes or less. While as low a temperature as possible is desirable to improve the efficiency of later cryogenic processing, the temperature to which the liquid is cooled depends on the desired viscosity of the liquid as it is transported through to later stages of processing. Thus, additives may be included, such as stabilizers, which allow cooling to lower temperatures while ensuring the liquid easily flows and improve the liquids freezing characteristics. The whey-based liquid is transported such as by being pumped, in step 308, to a frozen bead-making apparatus such as, for example, the device shown and described earlier with respect to FIG. 1. As mentioned, the consistency of the liquid may be adjusted to accommodate the pump 50 and the temperature of the liquid may be adjusted as well by well known cooling techniques that can be applied during transport to the freezing apparatus. The temperature and consistency may also be adjusted to help the development of uniformly-sized beads within the freezing apparatus. Depending on the viscosity of the original fluid, different temperatures and consistencies may be used for different liquids that are dispensed into the freezing apparatus.

The next step, 310, is to freeze the whey-based liquid into beads as described with respect to FIG. 1. These beads can then be transported to a packaging machine. The transporting of the beads can be accomplished in a variety of different ways such as by a feed screw, a moving conveyor belt, or gravity feed. The transporting means can also be cooled such that the beads remain cool while being transported to the packager.

One of ordinary skill will recognize that different flavored beads may be frozen in separate freezing apparatuses at the same time or in the same freezing apparatus in a sequential manner. These different flavor beads can then be combined in different ratios at the packaging machine. In this way, different combinations of flavored whey-based liquids may be created using the same set of beads in various permutations and combinations. Of course, a product consisting of one type of flavored bead is contemplated.

Once the beads are packaged and delivered to a consumer such as an individual, a retail location, a bar, a fitness center, a coffee shop, a store, or a restaurant, the beads are stored in a conventional freezer until they are used to make a beverage, or consumed in their beaded form. Although the beads are frozen at cryogenic temperatures, there is no requirement that they remain cooled to temperatures as low as −40° F. but, instead, may be maintained at the standard operating temperatures of commercial and consumer freezers. However, storing them at even lower temperatures may allow using less of the beads to cool a beverage to a desired temperature.

One ultimate use for the flavored frozen beads is to use them to produce a beverage for consumption. This can be accomplished in a variety of different ways without departing from the scope of the present invention. For example, for warm beverages as discussed below, the frozen beads may be brewed or steamed to reconstitute them. The frozen beads may also be ground similar to regular coffee beans and used to flavor beverages. However, another benefit of the frozen beads is that they may be used or mixed to create cold high-protein drinks while reducing or eliminating the need for ice cubes. Thus, the resulting beverage is not as watered-down as if ice cubes are used to make the cold drink. Also, because of the freezing method, ice crystal formation will be different than if ice cubes are used which improves the mouth-feel of the resulting beverage. Milk, water and other liquids may be used when reconstituting the frozen beads into the desired beverage.

Accordingly, the packaging of the frozen beads can be accomplished in a variety of different ways depending on the desired product. For example, the beads may be packed in a cup sized container that is for a single serving. For example, 8 oz. of beads (whatever variety or combination) may be packaged in a cup with room for 8 oz. of milk (or other liquid) to be added. Additional room can be provided in order to accommodate other additional flavors and confections. Alternatively, the beads can be packaged in bulk packages from which a user can extract the desired amount of product to be reconstituted.

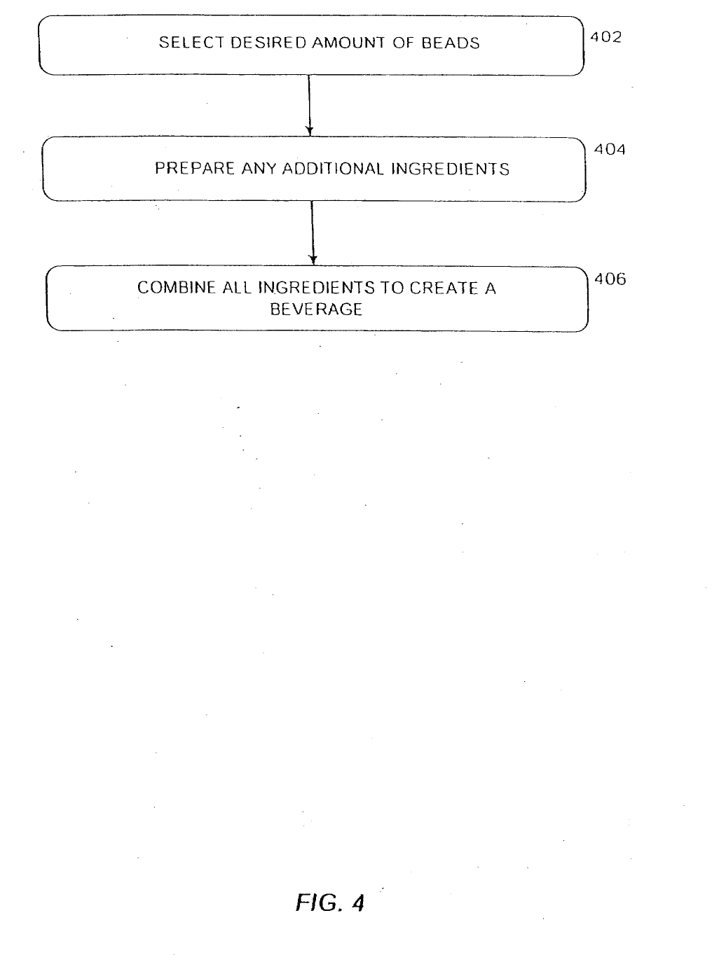

Utilizing either type of beads described earlier, various ingredients can be added to create cold beverages. In general, a flowchart is shown in FIG. 4 of a method for making a high-protein drink from the frozen beads described earlier. In step 402, the desired amount of beads are acquired. These beads can be any of the beads as described earlier. Depending on the desired beverage and the type of beads, the amount of beads selected in step 402 will vary.

The ingredients that will be combined with this beverage base can vary widely. For example, milk, frothed milk, steamed milk, cream, and whipped cream are all likely candidates to add so as to make a variety of cold beverages. Furthermore, the milk can vary from 1%, 2%, skim, lowfat, whole, and untraditional milk products such as soy, rice, goat, and the like. These additional ingredients can also include syrups and flavors such as those traditionally paired with whey-based beverages such as chocolate, vanilla, hazelnut, Irish cream, caramel, peppermint, butter rum, mint, coffee liqueur, and others. In the cold beverages fruity flavors, soda water, and ice can be added as well. Thus, in step 404, the additional ingredients are prepared in a manner appropriate for addition to the beverage base and then everything is combined in step 406 to create a cold beverage.

Using the inventive process described herein, a beaded product that is made from whey-protein powders currently on the market will contain little sugar and, thus, will remain free-flowing at relatively high temperatures such as those in a home freezer. A formulation where the total solids by weight is about 30% or below will help with formulating a bead that remains frozen at those temperatures. Furthermore, the sugar in the formulation can be limited to the lactose in the whey without any additional sugars being added. Additionally, the whey may be processed to reduce the amount of naturally occurring lactose. However, artificial sweeteners can be used to balance out the sweetness in the absence of large amounts of sugars, if desired.

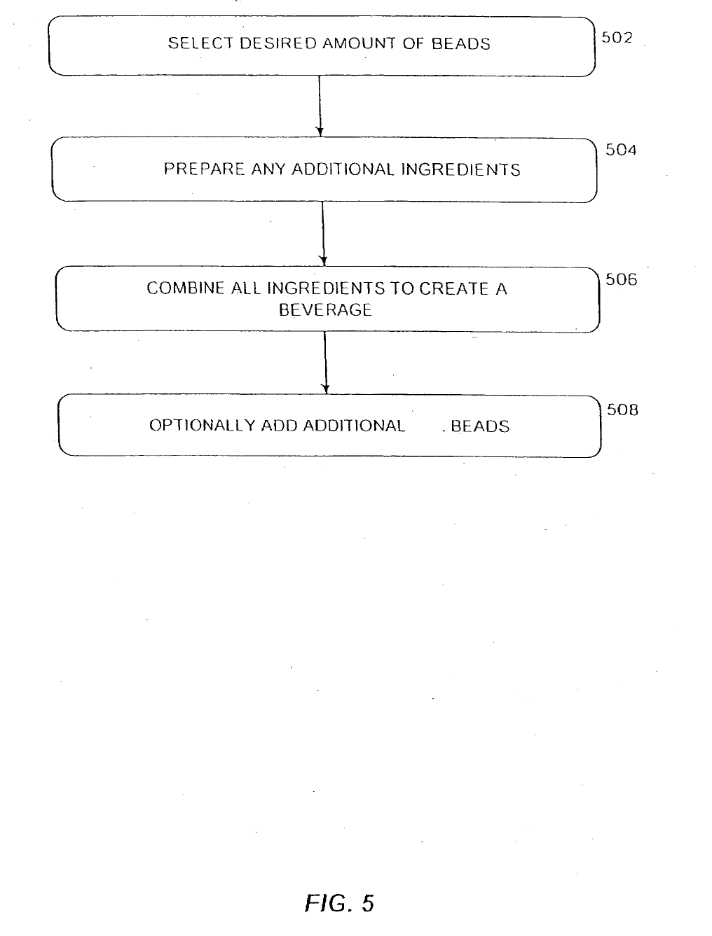

In general, a flowchart is shown in FIG. 5 of a method for making an whey-based drink from the frozen beads described earlier. In step 502, the desired amount of beads are selected. These beads are flash-frozen whey-based liquid beads as described earlier. Depending on the desired beverage and the type of beads, the amount of beads will vary. For example, for a 12 to 16 oz. drink, anywhere from about 1 oz. to 3 oz. of beads can be used. However, this ratio of ingredients can vary based on a desired beverage taste without departing from the scope of the present invention, as well as the relative concentration of the whey or protein within the beads. For example, removing various amounts of water from the whey-based liquid before freezing can be used to control flavor, texture, and concentration. In certain embodiments more than 50% of the water is removed from the whey-based liquid before freezing. Although less that this amount is contemplated, as well as more.

The ingredients that will be combined with this beverage base can vary widely. For example, milk, frothed milk, steamed milk, cream, and whipped cream are all likely candidates to add so as to make a variety of cold beverages. Furthermore, the milk can vary from 1%, 2%, skim, lowfat, whole, and untraditional milk products such as soy, rice, goat, and the like. These additional ingredients can also include syrups and flavors such as those traditionally paired with whey-based beverages such as chocolate, vanilla, hazelnut, Irish cream, caramel, peppermint, butter rum, mint, coffee liqueur, and others. In the cold beverages fruity flavors, soda water, and ice can be added as well. Thus, in step 504, the additional ingredients are prepared in a manner appropriate for addition to the beverage base and then everything is combined in step 506 to create a cold beverage. However, a warm beverage could be made as well. The beads or the combination of beads and ingredients can be warmed or heated by any of a variety of methods. Warming them in a pan, microwaving them, heating them with hot steam, etc. are all methods that can be used to create a reconstituted beverage base. Additionally, one of ordinary skill will recognize that any other well known method of warming the beads or ingredients can be utilized without departing from the scope of the present invention. The resulting beverage base can be a stand-alone beverage or potentially combined with other ingredients to form other high-protein beverages.

In step 508, the strength of the flavor in the beverage and the temperature of the beverage can be adjusted by adding other beads as desired by the user.

In addition to the beads discussed above, embodiments of the present invention also contemplate whey-based liquid beads that more closely resemble flash frozen ice cream products.

An exemplary method of manufacturing the whey-based frozen food product, includes preparing a formulation, wherein the formulation is preferably made by combining liquid ingredients, combining dry powders, and mixing the combined dry powders with the combined liquids to make the formulation, and where the method continues by agitating the formulation, pasteurizing the formulation if desired, homogenizing the formulation if desired, aging the formulation, and dripping the formulation into a cryogenic processor to form a particulate frozen food product. In a preferred embodiment, the homogenizing step acts to synchronize the pasteurizing step. In certain embodiments, based on the ingredients of the formulation, the pasteurizing step may be omitted. Also, one or more of the other steps in the above list may be optional depending on the formulation and desired end product.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of making a whey-flavored drink comprising:
combining one or more non-whey ingredients with one or more whey ingredients to form a whey-based liquid formulation;
cryogenically freezing the whey-based liquid formulation to form a first plurality of cryogenically frozen beads of the whey-based liquid formulation by dripping the whey-based liquid formulation into liquid nitrogen;
combining the first plurality of cryogenically frozen beads with a first liquid to form the whey-flavored drink without blending or ice;
combining one or more ingredients to form an additional liquid mix formulation;
cryogenically freezing the additional liquid mix formulation to form a second plurality of cryogenically frozen beads of the additional liquid mix formulation by dripping the additional liquid mix formulation into liquid nitrogen; and
combining the second plurality of frozen beads with the whey-flavored drink.

2. The method of claim 1, further comprising:
reducing an amount of naturally occurring sugars in the whey-based formulation prior to cryogenic freezing.

3. The method of claim 1, wherein 226.8 grams of the first plurality of cryogenically frozen beads is combined with 236.6 ml of milk in combining the first plurality of cryogenically frozen beads with the first liquid.

4. The method of claim 1, wherein a combined mass of the first plurality of cryogenically frozen beads and the second plurality of cryogenically frozen beads is 226.8 grams.

5. The method of claim 1, further comprising:
adding one or more sweeteners to the whey-based formulation prior to cryogenic freezing.

6. The method of claim 5, wherein the one or more sweeteners comprise an artificial sweetener.

7. The method of claim 1, further comprising:
packaging the first plurality of cryogenically frozen beads before combining the first plurality of cryogenically frozen beads.

8. The method of claim 7, further comprising:
packaging the second plurality of cryogenically frozen beads in a same package as the first plurality of cryogenically frozen beads, wherein the same package comprises at least two different flavors of cryogenically frozen beads.

9. The method of claim 7, further comprising:
delivering the first and second pluralities of cryogenically frozen beads to a retail location, a restaurant, a fitness center, a bar, a store, or a coffee shop, wherein delivering occurs before combining the first plurality of cryogenically frozen beads.

10. The method of claim 7, further comprising:
packaging the second plurality of cryogenically frozen beads before combining the second plurality of beads with the whey-flavored drink.

11. The method of claim 1, wherein more than 50% of the water is removed from the whey-based liquid formulation before cryogenically freezing the whey-based liquid formulation.

12. The method of claim 1, wherein the additional liquid mix formulation comprises whey.

13. The method of claim 12, wherein the additional liquid mix formulation is different than the whey-based liquid formulation.

14. The method of claim 1, wherein a combined mass of the first plurality of cryogenically frozen beads and the second plurality of cryogenically frozen beads is from 28.3 grams to 85.0 grams of beads and a total volume of the resulting whey-flavored drink is from 354.9 ml to 473.2 ml.

15. The method of claim 1, further comprising:
cooling the whey-based liquid formulation to 4.4 degrees Celsius in two minutes or less before cryogenically freezing the whey-based liquid.

16. The method of claim 1, further comprising:
cooling the additional liquid mix formulation to 4.4 degrees Celsius in two minutes or less before cryogenically freezing the whey-based liquid.

17. The method of claim 1, wherein approximately half of the water is removed from the whey-based liquid formulation before cryogenically freezing the whey-based liquid formulation.

18. The method of claim 17, wherein half of the water is removed from the whey-based liquid formulation before cryogenically freezing the whey-based liquid formulation.

19. The method of claim 1, further comprising:
adding an additional flavoring to the whey-flavored drink.

20. The method of claim 19, wherein adding the additional flavoring occurs after combining the second plurality of frozen beads with the whey-flavored drink.
